(19) United States
(12) Patent Application Publication
(10) Pub. No.: US 2024/0253829 A1
(43) Pub. Date: Aug. 1, 2024

(54) RADIO RANGING FOR GPS-DENIED LANDING OF UNMANNED AIRCRAFT

(71) Applicant: Rockwell Collins, Inc., Cedar Rapids, IA (US)

(72) Inventors: Eric T. Brewer, Ashburn, VA (US); William T. Kirchner, Ashburn, VA (US); Vladislav Gavrilets, McLean, VA (US)

(21) Appl. No.: 18/103,683

(22) Filed: Jan. 31, 2023

(51) Int. Cl. B64U 70/40; G05D 1/06

(52) U.S. Cl. CPC B64U 70/40; B64U 2201/10

(57) ABSTRACT

A system utilizes two ground-based radios; each radio is equipped for two-way timing and ranging. An aerial vehicle receives radio signals from the two ground-based radios and triangulates its location with respect to those two ground-based radios. The aerial vehicle then executes a landing procedure at a landing site with respect to the triangulated location. The aerial vehicle includes a barometer, radar, or laser altimeter for vertical measurement. The aerial vehicle also includes an inertial measurement unit (IMU), air data system, and magnetometer. The ground-based radios may supply a ground level altitude measurement. The aerial vehicle may perform an acquisition orbit for improved accuracy. The acquisition orbit provides an expanded range of geometries with respect to the two ground-based radios.

### BACKGROUND

Most tactical unmanned aerial vehicles rely on the Global Positioning System (GPS) for landing. Current solutions for precision landing of unmanned aerial vehicles (UAVs) in GPS denied conditions have undesirable limitations. For example, ground-based radars can be expensive and bulky to carry, and cumbersome to set up at the landing site. Vision based solutions have limited range and present challenges for coarse acquisition as the vehicle enters the airspace close to the touchdown point, for example during a transition phase from fixed-wing flight to vertical takeoff and landing (VTOL) in the case of a hybrid VTOL vehicle.

### SUMMARY

In one aspect, embodiments of the inventive concepts disclosed herein are directed to a system utilizing two ground-based radios. Each radio is equipped for two-way timing and ranging. An aerial vehicle receives radio signals from the two ground-based radios and triangulates its location with respect to those two ground-based radios. The aerial vehicle then executes a landing procedure at a landing site with respect to the triangulated location.

In a further aspect, the aerial vehicle includes a barometer, radar, or laser altimeter for vertical measurement. The ground-based radios may supply a ground level altitude measurement. The aerial vehicle may also include additional sensors for navigation.

In a further aspect, the aerial vehicle may perform an acquisition orbit for improved accuracy. The acquisition orbit provides an expanded range of geometries with respect to the two ground-based radios.

It is to be understood that both the foregoing general description and the following detailed description are exemplary and explanatory only and should not restrict the scope of the claims. The accompanying drawings, which are incorporated in and constitute a part of the specification, illustrate exemplary embodiments of the inventive concepts disclosed herein and together with the general description, serve to explain the principles.

### BRIEF DESCRIPTION OF THE DRAWINGS

The numerous advantages of the embodiments of the inventive concepts disclosed herein may be better understood by those skilled in the art by reference to the accompanying figures in which:

FIG. 1 shows a block diagram of a system according to an exemplary embodiment;

FIG. 2 shows a block representation environmental view of a system according to an exemplary embodiment;

FIG. 3 shows a flowchart of a method according to an exemplary embodiment;

### DETAILED DESCRIPTION

Before explaining various embodiments of the inventive concepts disclosed herein in detail, it is to be understood that the inventive concepts are not limited in their application to the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of a feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Also, while various components may be depicted as being connected directly, direct connection is not a requirement. Components may be in data communication with intervening components that are not illustrated or described.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in at least one embodiment” in the specification does not necessarily refer to the same embodiment. Embodiments of the inventive concepts disclosed may include one or more of the features expressly described or inherently present herein, or any combination or sub-combination of two or more such features.

Broadly, embodiments of the inventive concepts disclosed herein are directed to a system utilizing two ground-based radios. Each radio is equipped for two-way timing and ranging. An aerial vehicle receives radio signals from the two ground-based radios and triangulates its location with respect to those two ground-based radios. The aerial vehicle then executes a landing procedure at a landing site with respect to the triangulated location. The aerial vehicle includes a barometer, radar, or laser altimeter for vertical measurement. The aerial vehicle also includes an inertial measurement unit (IMU), air data system, and magnetometer. The ground-based radios may supply a ground level altitude measurement. The aerial vehicle may perform an acquisition orbit for improved accuracy. The acquisition orbit provides an expanded range of geometries with respect to the two ground-based radios.

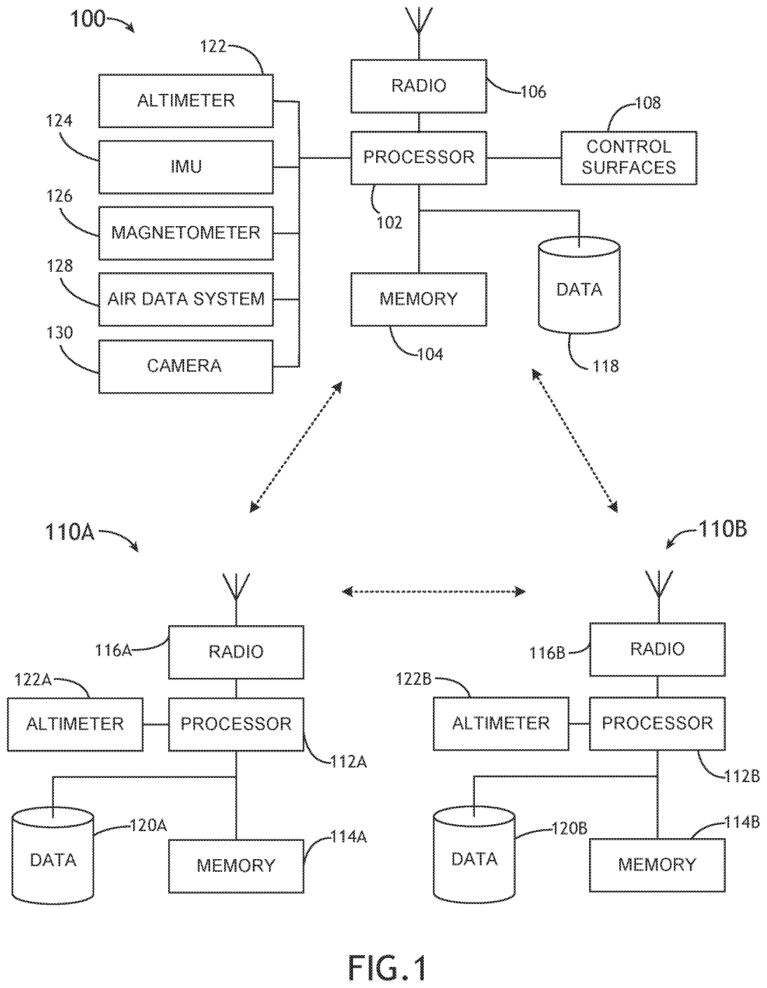

Referring to FIG. 1, a block diagram of a system according to an exemplary embodiment is shown. The system includes an aerial vehicle 100 with a processor 102, memory 104 for storing processor executable code, and one or more radios 106 connected to the processor 102; the radios 106 may be software defined radios. The processor 102 is configured to receive radio signals via the one or more radios 106 from two ground-based radio sources 110A, 110B and determine a current location of the aerial vehicle 100 with respect to the two ground-based radio sources 110A, 110B. The processor 102 may determine the location of the aerial vehicle 100 via a range finding algorithm to each of the ground-based radio sources 110A, 110B.

Each of the two ground-based radio sources 110A, 110B may be equipped with a navigation system and identify where it is in an absolute sense (latitude, longitude, and altitude). Furthermore, each of the two ground-based radio sources 110A, 110B may transmit its distance from a desired touch down point (i.e., a 50 meter offset and 20 meter offset respectively).

Once the processor 102 determines the location of the aerial vehicle 100, the processor 102 may execute a predetermined landing procedure at a location relative to the two ground-based radio sources 110A, 110B via actuation of control surfaces 108 of the aerial vehicle 100.

In at least one embodiment, each of the two ground-based radio sources 110A, 110B may include a processor 112A, 112B configured via processor executable code stored in a memory 114A, 114B. Each processor 112A, 112B may communicate with each other and with the aerial vehicle processor 102. In at least one embodiment, each of the two ground-based radio source processors 112A, 112B may determine a linear distance between the two ground-based radio sources 110A, 110B (i.e., via an external measurement from a laser range finder). Such linear distance may be transmitted to the aerial vehicle 100 to enhance the aerial vehicle processor's 102 location determination. Alternatively, or in addition, the aerial vehicle may include on RF angle of arrival sensor in data communication with the processor 102. Based on the known linear distance and measurements from the RF angle of arrival sensor, the processor 102 may determine the location of the aerial vehicle 100 in space.

In at least one embodiment, the processor 102 executes an acquisition orbit maneuver via actuation of the control surfaces 108. The acquisition orbit places the aerial vehicle 100 in different positions and orientations with respect to the two ground-based radio sources 110A, 110B, providing a better, more diverse sample of radio signals for more accurate location determination (i.e., via triangulation). In at least one embodiment, the measurements taken from the acquisition orbit are blended with the inertial location to get a better position fixation. The acquisition orbit may be configured to return the aerial vehicle 100 to the starting point of the acquisition orbit such that the processor 102 may then execute the landing procedure.

In at least one embodiment, the aerial vehicle 100 may include an altimeter 122 in data communication with the processor 102. The altimeter 122 provides additional information for determining the location of the aerial vehicle 100 in space. The altimeter 122 may comprise a barometric altimeter, sonar, radar, a laser range finder, or the like (i.e., above ground level sensors). In at least one embodiment, where the altimeter 122 comprises a barometric altimeter, one or more of the two ground-based radio sources 110A, 110B may also include a barometric altimeter 122A, 122B. The two ground-based radio sources 110A, 110B may transmit a ground-level barometric altimeter measurement to the aerial vehicle 100. The aerial vehicle processor 102 may then continuously compare a local barometric altimeter measurement with the received ground-level barometric altimeter measurement, and determine an actual altitude based on the difference.

In at least one embodiment, the aerial vehicle 100 includes an IMU 124, magnetometer 126, and/or air data system 128 in data communication with the processor 102. The IMU 124, magnetometer 126, and air data system 128 are useful for navigation and maneuvering once the processor 102 has determined the location of the aerial vehicle 100.

In at least one embodiment, the aerial vehicle 100 includes at least one vision-based sensor 130 such as a camera in data communication with the processor 102. The processor 100 may perform object recognition on ground images from the at least one vision-based sensor 130 to enhance the location determination. For example, an operator of one of the two ground-based radio sources 110A, 110B may place a predefined marker at a desired touchdown point that may be identified via the vision-based sensor 130. Alternatively, or in addition, where two or more vision-based sensors 130 are disposed a known distance apart and at known orientations, the processor 100 may determine an altitude based on differences in images from the two or more vision-based sensors 130.

In at least one embodiment, the aerial vehicle 100 may include a data storage element 118 in data communication with the processor 102. The data storage element 118 may include a terrain map or digital terrain elevation database. When the processor 102 has determined the aerial vehicle's 100 location relative to the two ground-based radio sources 110A, 110B, the processor 100 may reference the terrain map or digital terrain elevation database to determine the aerial vehicle's 100 altitude. Furthermore, each of the two ground-based radio sources 110A, 110B may include a data storage element 120A, 120B storing such terrain map or digital elevation database, or the corresponding processor 112A, 112B may gather such data via onboard sensors, and supply such data to the aerial vehicle 100 via the radio signals.

In at least one embodiment, each of the two ground-based radio sources 110A, 110B includes one or more radios 116A, 116B. Each radio 116A, 116B may include one or more antennas and processors; such processors or processing electronics including RF electronics. The antennas may include one or more directional antennas (i.e., a dish, an electronically scanned era, or the like). Each corresponding processor 112A, 112B may measure the directionality of pings from the aerial vehicle 100, and may thereby improve accuracy.

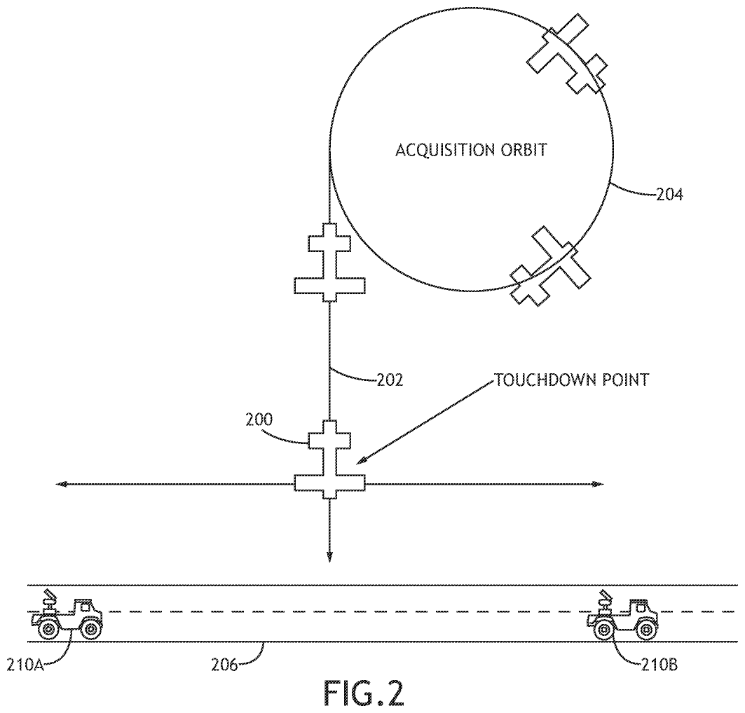

Referring to FIG. 2, a block representation environmental view of a system according to an exemplary embodiment is shown. An aerial vehicle 200 making a landing approach 202 in a GPS denied environment receives radio signals from two ground-based radio sources 210A, 210B. The aerial vehicle 200 locates its position with respect to the two ground-based radio sources 210A, 210B and executes a landing procedure based on the located position, relative to the two ground-based radio sources 210A, 210B. In at least one embodiment, the landing approach 202 may be defined orthogonal to an axis defined by the two ground-based radio sources 210A, 210B, which may correspond to a road 206. In such embodiment, an orthogonal landing approach may correspond to an orthogonal road at an intersection. Furthermore, the landing procedure may be defined to bring the aerial vehicle to the road 206 for retrieval/refueling.

In at least one embodiment, the aerial vehicle 200 is configured to execute an acquisition orbit 204 to get a spatially diverse exposure to the radio signals from the two ground-based radio sources 210A, 210B. Sampling the radio signals from different points in the acquisition orbit 204 allows the aerial vehicle 200 to define its location with greater precision before executing the landing procedure.

In at least one embodiment, the two ground-based radio sources 210A, 210B are disposed some known distance apart. The two ground-based radio sources 210A, 210B may include some range finding mechanism such as a laser range finder to determine the distance between the two ground-based radio sources 210A, 210B, and transmit such distance to the aerial vehicle 200 via the radio signal produced by the two ground-based radio sources 210A, 210B. In at least one embodiment, an operator measures a range from each of the two ground-based radio sources 210A, 210B to a desired touchdown point to completely determine the desired touchdown point with respect to the two ground-based radio sources 210A, 210B. The aerial vehicle 200 may then make adjustments to touchdown at that point.

In at least one embodiment, the aerial vehicle 200 may include an altimeter. In the absence of GPS to locate the aerial vehicle 200 in 3D space, the altimeter may enable the aerial vehicle 200 to more fully define its location in a 3D space. The altimeter may comprise a radar, sonar, laser range finder, vision-based distance measurement system, barometric altimeter, or the like. Where the aerial vehicle 200 includes a barometric altimeter, the aerial vehicle 200 may identify its altitude based on a difference between a barometric altimeter measurement and a ground level barometric measurement received from the two ground-based radio sources 210A, 210B.

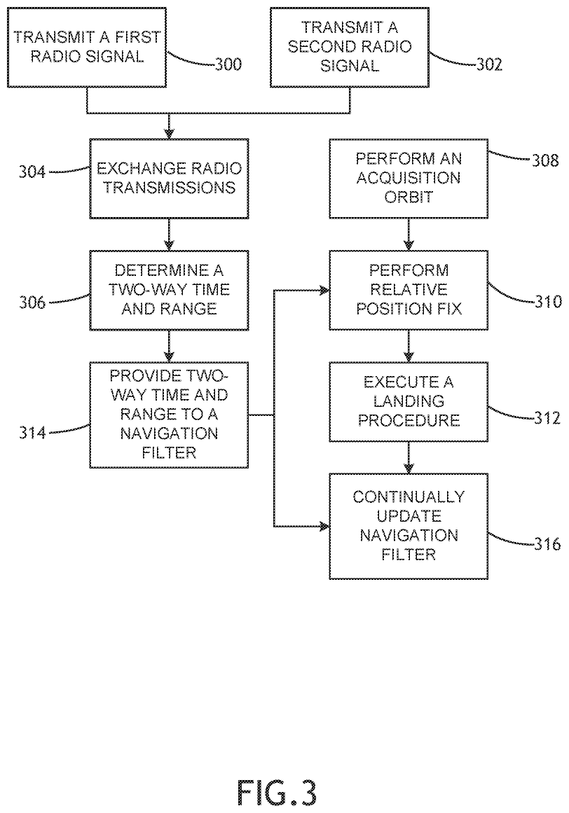

Referring to FIG. 3, a flowchart of a method according to an exemplary embodiment is shown. Two ground-based radio sources (i.e., radio equipped ground vehicles) transmit radio signals 300, 302. An aerial vehicle and the ground-based radio sources continuously exchange 340 radio transmission. Based on the two radio signals, the aerial vehicle determines 306 a two-way time and range with respect to the two radio signals. The two-way time and range is provided 314 to a navigation filter. The process of exchanging 304 radio transmissions, determining 306 a two-way time and range, and providing 314 the two-way time and range to a navigation filter is continuously or periodically repeated.

In at least one embodiment, the aerial vehicle may perform 308 an acquisition orbit to produce geometric diversity with respect to the two ground-based radio sources. The aerial vehicle may include an acquisition filter to establish a coarse acquisition fix.

Based on data from the navigation filter, potentially including data from the acquisition orbit, the aerial vehicle performs 310 a relative navigation fix, Such relative navigation fix may be based on triangulation where the aerial vehicle knows the angle between radio signals (either by direct measurement or by some communication from the two ground-based radio sources). Alternatively, or in addition, the relative navigation fix may be based on a distance measurement to each of the two ground-based radio sources. Geometric diversity from the acquisition orbit enhances the accuracy of performing 310 the relative position fix.

The methodologies for performing 310 the relative position fix, and two-way timing and ranging, may be more fully understood with reference to U.S. patent application Ser. No. 17/587,926 (filed Jan. 28, 2022), which is hereby incorporated by reference.

In at least one embodiment, the aerial vehicle determines its own altitude and includes the altitude in the relative position fix. Such determination may be by an above ground level sensor (i.e., sonar, radar, laser range finder, or the like), or a barometric altimeter. The altitude may be determined by a comparison of a barometric altimeter measurement on the aerial vehicle with a ground level barometric altimeter measurement.

When the aerial vehicle has performed 310 the relative position fix, it executes 312 a landing procedure to land at a touchdown point defined with respect to the two ground-based radio sources. The touchdown point may be predefined as a midpoint between the two ground-based radio sources, or at some offset to the two ground-based radio sources. In at least one embodiment, the landing approach may be defined orthogonal to an axis between the two ground-based radio sources to easily enable landing at an intersection where the two ground-based radio sources are disposed in vehicles.

In at least one embodiment, the aerial vehicle continually updates 316 the navigation filter. Such updates are based continually radio signals from the ground-based radio sources.

It is believed that the inventive concepts disclosed herein and many of their attendant advantages will be understood by the foregoing description of embodiments of the inventive concepts, and it will be apparent that various changes may be made in the form, construction, and arrangement of the components thereof without departing from the broad scope of the inventive concepts disclosed herein or without sacrificing all of their material advantages; and individual features from various embodiments may be combined to arrive at other embodiments. The forms herein before described being merely explanatory embodiments thereof, it is the intention of the following claims to encompass and include such changes. Furthermore, any of the features disclosed in relation to any of the individual embodiments may be incorporated into any other embodiment.

What is claimed is:

1. An aerial vehicle comprising:
an antenna;
one or more sensors configured for navigation and maneuvering; and
at least one processor in data communication with the antenna and a memory storing processor executable code for configuring the at least one processor to:
receive at least two radio signals;
determine a relative location of the aerial vehicle with respect to the at least two radio signals;
determine a landing location relative to the at least two radio signals; and
execute a landing procedure at the landing location.

2. The aerial vehicle of claim 1, wherein the at least one processor is further configured to execute an acquisition orbit procedure while receiving the at least two radio signals.

3. The aerial vehicle of claim 1, further comprising an altimeter in data communication with the at least one processor, wherein:
the at least one processor is further configured to determine an altitude based on the altimeter; and
the relative location of the aerial vehicle comprises the altitude.

4. The aerial vehicle of claim 3, wherein:
the altimeter comprises a barometric altimeter;
the at least one processor is further configured to receive a ground level barometric altimeter signal via the antenna; and
determining the relative altitude comprises comparing the ground level barometric altimeter signal to a measurement from the barometric altimeter.

5. The aerial vehicle of claim 1, further comprising a data storage element in data communication with the at least one processor, wherein:
the at least one processor is further configured to:
retrieve a stored terrain map from the data storage device; and
receive a location corresponding to each of the at least two radio signals; and
determining the relative location comprises comparing the received locations to the stored terrain map.

6. The aerial vehicle of claim 1, further comprising at least one camera in data communication with the at least one processor, wherein the at least one processor is further configured to:
receive an image stream from the at least one camera; and
locate the landing location in the image stream.

7. The aerial vehicle of claim 1, wherein:
the at least one processor is further configured to receive a relative separation between the at least two radio signals; and
determining a relative location of the aerial vehicle comprises triangulation including the relative separation.

8. A method comprising:
receiving at least two radio signals from two ground-based radio sources;
determining a relative location of the aerial vehicle with respect to the two ground-based radio sources;
determining a landing location relative to the two ground-based radio sources; and
executing a landing procedure at the landing location.

9. The method of claim 8, further comprising executing an acquisition orbit procedure while receiving the at least two radio signals.

10. The method of claim 8, further comprising determining an altitude based on an altimeter, wherein the relative location of the aerial vehicle comprises the altitude.

11. The method of claim 10, further comprising:
performing a ground level barometric altitude measurement via at least one of the two ground-based radio sources; and
comparing the ground level barometric altitude measurement to an aerial vehicle barometric altimeter measurement,
wherein the altimeter comprises a barometric altimeter.

12. The method of claim 8, further comprising:
receiving a location corresponding to each of the two ground-based radio sources; and
comparing the received locations to a terrain map.

13. The method of claim 8, further comprising receiving a relative separation between the two ground-based radio sources, wherein determining a relative location of the aerial vehicle comprises triangulation including the relative separation.

14. A system comprising:
two ground-based radio sources; and
an aerial vehicle comprising:
an antenna;
one or more sensors configured for navigation and maneuvering; and
at least one processor in data communication with the antenna and a memory storing processor executable code for configuring the at least one processor to:
receive radio signals from the two ground-based radio sources;
determine a relative location of the aerial vehicle with respect to the two ground-based radio sources;
determine a landing location relative to the two ground-based radio sources; and
execute a landing procedure at the landing location.

15. The system of claim 14, wherein the at least one processor is further configured to execute an acquisition orbit procedure while receiving the at least two radio signals.

16. The system of claim 14, further comprising an altimeter in data communication with the at least one processor, wherein:
the at least one processor is further configured to determine an altitude based on the altimeter; and
the relative location of the aerial vehicle comprises the altitude.

17. The system of claim 16, wherein:
the altimeter comprises a barometric altimeter;
each ground-based radio source is configured to perform a ground level barometric altitude measurement;
the at least one processor is further configured to receive the ground level barometric altitude measurement via the antenna; and
determining the relative altitude comprises comparing the ground level barometric altitude measurement signal to a measurement from the barometric altimeter.

18. The system of claim 14, wherein:
the aerial vehicle further comprises a data storage element in data communication with the at least one processor;
the at least one processor is further configured to:
retrieve a stored terrain map from the data storage device; and
receive a location corresponding to each of the two ground-based radio sources; and
determining the relative location comprises comparing the received locations to the stored terrain map.

19. The system of claim 14, wherein the one or more sensors comprise and IMU, a magnetometer, and air data system.

20. The system of claim 14, wherein:
the at least one processor is further configured to receive a relative separation between the two ground-based radio sources; and
determining a relative location of the aerial vehicle comprises triangulation including the relative separation.
